(19) United States
(12) Patent Application Publication
(10) Pub. No.: US 2005/0185637 A1
(43) Pub. Date: Aug. 25, 2005

(54) Integrated IP-capable telephonic communications system, IP terminal information management method, IP terminal information management program, and protocol control device

(75) Inventor: Teruo Nakamura, Tokyo (JP)

Correspondence Address: MICHAEL BEST & FRIEDRICH LLC, 401 NORTH MICHIGAN AVENUE, SUITE 1900, CHICAGO, IL, 60611-4212, US

(73) Assignee: NEC Corporation, Tokyo (JP)

(21) Appl. No.: 11/060,985

(22) Filed: Feb. 18, 2005

(30) Foreign Application Priority Data
Feb. 23, 2004 (JP) 2004-045967

(51) Int. Cl. H04L 12/66

(52) U.S. Cl. 370/352

(57) ABSTRACT

Protocol control devices each have a database for storing application information concerning each of a number of IP (Internet Protocol) terminals controlled by the protocol control device. A dedicated maintenance terminal has a database for temporarily storing application information possessed by each protocol control device. An IP-capable PBX receives the application information of a designated IP terminal from the relevant protocol control device in response to a back-up command from the dedicated maintenance terminal. The dedicated maintenance terminal receives this application information and saves it temporarily for back-up purposes in a database.

This application claims priority of Japanese patent application number 2004-045967, filed Feb. 23, 2004.

### FIELD OF THE INVENTION

This invention relates to an integrated IP-capable telephonic communications system that provides a PBX (Private Branch eXchange) function by controlling an IP (Internet Protocol) telephone or personal computer equipped with VoIP (Voice over IP) software on an IP network, an IP terminal information management method in this integrated IP-capable telephonic communications system, an IP terminal information management program and a protocol control device. More particularly, the invention relates to an integrated IP-capable telephonic communications system, IP terminal information management method, IP terminal information management program and protocol control device for managing application information of an IP terminal typified by an IP telephone or personal computer.

### BACKGROUND OF THE INVENTION

IP telephony have become widely available in recent years. IP telephony integrates voice communication by an existing telephone into an IP network using VoIP technology without relying upon a public line, thereby realizing a reduction in cost and an improvement in operations efficiency. In order to introduce such an IP telephone, an Internet Protocol-capable Public Branch Exchange (IP-PBX) is required.

An IP-PBX implements control of incoming and outgoing telephone calls, which ordinarily is performed by a Public Branch Exchange (PBX) for telephone lines, over an IP network and has conventional PBX functions such as an extension/outside-line call function, call-back (a function whereby a call on hold can be picked up from another telephone), and various call transfer functions.

In a network having such an IP-PBX (namely an integrated IP-capable telephonic communication system), IP terminals typified by personal computers equipped with VoIP software and IP telephones are capable of being accommodated, and data, voice and images and the like are combined by the IP.

Application information usually is preserved in an IP terminal.

Application information includes voice/electronic-message information concerning the IP terminal, the status to be retained at each terminal, such as lamp status, incoming-call refuse status, and information that has accumulated, by way of example.

Techniques whereby this application information is retained individually at each IP terminal has been proposed heretofore (for example, see the specification of Japanese Patent Kokai Publication No. JP-P2003-259024A).

Further, a scheme whereby a database is constructed at an external server and application information is managed in centralized form also has been proposed (for example, see the specification of Japanese Patent Kokai Publication No. JP-P2002-152224A).

[Patent Document 1]

Japanese Patent Kokai Publication No. JP-P2003-259024A

[Patent Document 2]

Japanese Patent Kokai Publication No. JP-P2002-152224A

### SUMMARY OF THE DISCLOSURE

However, certain problems arise with a scheme for centralized management of application information by an external server. One problem is the expense entailed by constructing the external server, and another problem is that application information cannot be acquired in the event that the external server shuts down because of malfunction or some other reason.

Further, a problem is encountered also with the scheme for retaining application information individually at each IP terminal. Specifically, the user of an IP terminal may employ a desktop personal computer as the IP terminal at certain times and a notebook personal computer as the IP terminal at other times. The user cannot carry application information about when multiple terminals are thus used in common as an IP terminal.

Accordingly, an object of the present invention is to provide an integrated IP-capable telephonic communications system, IP terminal information management method, IP terminal information management program and protocol control device that make it possible to acquire application information without being affected by external server failure or the like, and that make it possible to carry about application information when common use is made of a plurality of terminals as an IP terminal.

According to a first aspect of the present invention, there is provided an integrated IP-capable telephonic communications system having a protocol control device to which one or more IP terminals have been connected, an IP-capable private branch exchange to which one or more protocol control devices have been connected, and a dedicated maintenance terminal connected to the IP-capable private branch exchange, wherein the protocol control device has a protocol control device database in which application information of each IP terminal has been stored; the IP-capable private branch exchange, based upon an application information read-out request from the dedicated maintenance terminal, transmits an application information read-out command to the protocol control device and transmits application information from the protocol control device to the dedicated maintenance terminal; and the dedicated maintenance terminal has a dedicated maintenance terminal database in which application information is stored and is adapted to store application information from the IP-capable private branch exchange in the dedicated maintenance terminal database.

With an integrated IP-capable telephonic communications system thus constructed, an existing protocol control device is equipped with a database storing application information and therefore it is no longer necessary to separately provide an external server for storing application information. As a result, the expense needed to set up an external server can be reduced and application information can be acquired at the dedicated maintenance terminal or the like without any influence from external server failure.

Furthermore, the application information of a plurality of IP terminals is managed centrally by the protocol control device connected to each IP terminal and not by each IP terminal individually. This makes it possible for application information to be carried about between IP terminals. As a result, the user of an IP terminal can freely select and use any IP terminal.

Moreover, by transmitting an application information read-out request from the dedicated maintenance terminal to the IP-capable private branch exchange (IP-PBX), an application information read-out command is transmitted from the IP-PBX to the protocol control device and protocol information that has been extracted from the database possessed by this protocol control device is transmitted to the dedicated maintenance terminal via the IP-PBX. This means that application information of a desired IP terminal from application information being managed centrally by the protocol control device can be saved temporarily for back-up purposes in the database possessed by the dedicated maintenance terminal.

Further, according to a second aspect of the present invention the protocol control device in the integrated IP-capable telephonic communications system includes: the protocol control device database; a database management processing unit for extracting application information from the protocol control device database based upon an application information read-out command from the IP-capable private branch exchange; and a protocol control device signal transceive processing unit for transmitting the extracted application information to the IP-capable private branch exchange. The IP-capable private branch exchange includes a maintenance terminal controller for receiving an application information read-out request from the dedicated maintenance terminal and transmitting application information to the dedicated maintenance terminal, and a transceive signal processing unit for the IP-capable private branch exchange for transmitting an application information read-out command to the protocol control device and receiving application information from the protocol control device. The dedicated maintenance terminal includes the dedicated maintenance terminal database; a dedicated maintenance terminal signal transceive processing unit for transmitting an application information read-out request to the IP-capable private branch exchange and receiving application information from the IP-capable private branch exchange; and an application information management processing unit for storing application information, which has been received by the dedicated maintenance terminal signal transceive processing unit, in the dedicated maintenance terminal database.

With an integrated IP-capable telephonic communications system thus constructed, it is possible to save application information in an existing device, namely the protocol control device. This makes it unnecessary to install an external server or the like anew and enables a reduction in cost.

Furthermore, in a case where multiple IP terminals have been connected to a single protocol control device, application information that has been saved in this protocol control device can be carried about in each IP terminal.

Moreover, the application information of a designated IP terminal can be received from application information that has been stored in the protocol control device and this information can be saved temporarily for back-up purposes in the dedicated maintenance terminal.

Further, according to a third aspect of the present invention, there is provided an integrated IP-capable telephonic communications system having a protocol control device to which one or more IP terminals have been connected, an IP-capable private branch exchange to which one or more protocol control devices have been connected, and a dedicated maintenance terminal connected to the IP-capable private branch exchange. The dedicated maintenance terminal has a dedicated maintenance terminal database in which application information has been stored and extracts application information from the dedicated maintenance terminal database and transmits it to the IP-capable private branch exchange. The IP-capable private branch exchange transmits the application information from the dedicated maintenance terminal to the protocol control device. The protocol control device has a protocol control device database in which application information of an IP terminal has been stored and changes application information, which has been stored in this protocol control device database, to application information that has been transmitted from the IP-capable private branch exchange.

With an integrated IP-capable telephonic communications system thus constructed, operating the dedicated maintenance terminal makes it possible to change (to load or write) application information that has been saved by the protocol control device to application information that has been transmitted from the dedicated maintenance terminal.

Further, according to a fourth aspect of the present invention, there is provided an integrated IP-capable telephonic communications system having a protocol control device to which one or more IP terminals have been connected, an IP-capable private branch exchange to which one or more protocol control devices have been connected, and a dedicated maintenance terminal connected to the IP-capable private branch exchange. The IP-capable private branch exchange, based upon an IP terminal status confirmation request from the dedicated maintenance terminal, checks a change in status of an IP terminal and transmits result of the check to the dedicated maintenance terminal. The dedicated maintenance terminal has a dedicated maintenance terminal database in which application information has been stored and extracts application information from the dedicated maintenance terminal database and transmits it to the IP-capable private branch exchange. The IP-capable private branch exchange transmits application information from the dedicated maintenance terminal to the protocol control device. The protocol control device has a protocol control device database in which application information of an IP terminal has been stored and changes application information, which has been stored in this protocol control device database, to application information that has been transmitted from the IP-capable private branch exchange.

An integrated IP-capable telephonic communications system thus constructed is such that if an IP terminal has logged in, operating the dedicated maintenance terminal makes it possible to load application information of the IP terminal that has logged in from application information that has been saved in the protocol control device.

Further, according to a fifth aspect of the present invention, there is provided an IP terminal information management method for managing application information of an IP terminal in an integrated IP-capable telephonic communications system. The method comprises the following steps: read-out request transmit processing for transmitting an application information read-out request from a dedicated maintenance terminal to an IP-capable private branch exchange; read-out command transmit processing for transmitting an application information read-out command from the IP-capable private branch exchange to a protocol control device; information read-out processing executed by the protocol control device for extracting application information from a protocol control device database in which application information of IP terminals has been stored; read-out result transmit processing for transmitting the extracted application information from the protocol control device to the dedicated maintenance terminal via the IP-capable private branch exchange; and read-out result store processing executed by the dedicated maintenance terminal for storing application information from the IP-capable private branch exchange to a dedicated maintenance terminal database in which application information is stored.

With the IP terminal information management method according to the present invention, application information concerning IP terminals can be managed centrally by the protocol control device. This makes it unnecessary to install an external server for storing application information and enables a reduction in cost.

Moreover, application information that has been saved in a protocol control device to which multiple IP terminals have been connected in common can be carried about and used at each of the IP terminals. As a result, the user of an IP terminal can freely select an IP terminal from among these IP terminals.

Furthermore, application information being managed centrally by the protocol control device can be transmitted to the dedicated maintenance terminal where it can be saved temporarily for back-up purposes.

Further, according to a sixth aspect of the present invention, there is provided an IP terminal information management method for managing application information of an IP terminal in an integrated IP-capable telephonic communications system. The method comprises the following steps: information extraction processing executed by a dedicated maintenance terminal for extracting application information from a dedicated maintenance terminal database in which application information has been stored; write-information transmit processing for transmitting application information from the dedicated maintenance terminal to a protocol control device via an IP-capable private branch exchange; and information write processing executed by the protocol control device for changing application information, which has already been stored in a protocol control device database in which application information of IP terminals has been stored, to application information that has been transmitted from the IP-capable private branch exchange.

With the IP terminal information management method according to the present invention, application information that has been transmitted from the dedicated maintenance terminal can be written to the database of the protocol control device.

Further, according to a seventh aspect of the present invention, there is provided an IP terminal information management method for managing application information of an IP terminal in an integrated IP-capable telephonic communications system. The method comprises the following steps: confirmation request transmit processing for transmitting an IP terminal status confirmation request from a dedicated maintenance terminal to an IP-capable private branch exchange; status-change confirm processing executed by the IP-capable private branch exchange for checking for a change in status of an IP terminal; check-result transmit processing for transmitting result of the check of change in status of the IP terminal from the IP-capable private branch exchange to the dedicated maintenance terminal; information extraction processing executed by the dedicated maintenance terminal for extracting application information from a dedicated maintenance terminal database in which application information has been stored; write-information transmit processing for transmitting application information from the dedicated maintenance terminal to a protocol control device via the IP-capable private branch exchange; and information write processing executed by the protocol control device for changing application information, which has already been stored in a protocol control device database in which application information of the IP terminal has been stored, to application information that has been transmitted from the IP-capable private branch exchange.

The IP terminal information management method according to the present invention is such that when a user has logged in at an IP terminal, application information that has been transmitted from the dedicated maintenance terminal can be written to the database of the protocol control device.

Further, according to an eighth aspect of the present invention, there is provided an IP terminal information management program for causing a prescribed apparatus, with which an integrated IP-capable telephonic communications system has been equipped, to execute processing for managing application information of an IP terminal. The program comprises the following steps: causing a dedicated maintenance terminal to execute read-out request transmit processing for transmitting an application information read-out request to an IP-capable private branch exchange; causing the IP-capable private branch exchange to execute read-out command transmit processing for transmitting an application information read-out command to a protocol control device based upon receipt of the application information read-out request; causing the protocol control device to execute information read-out processing for extracting application information from a protocol control device database in which application information of IP terminals has been stored, and read-out result transmit processing for transmitting the extracted application information to the dedicated maintenance terminal via the IP-capable private branch exchange; and causing the dedicated maintenance terminal to execute read-out result store processing for storing application information from the IP-capable private branch exchange to a dedicated maintenance terminal database in which application information is stored.

By causing a prescribed apparatus with which an integrated IP-capable telephonic communications system has been equipped to execute the IP terminal information management program created as described above, application information concerning multiple IP terminals managed centrally by the protocol control device can be transmitted to the dedicated maintenance terminal where the information can be saved temporarily for back-up purposes.

Further, according to a ninth aspect of the present invention, there is provided an IP terminal information management program for causing a prescribed apparatus, with which an integrated IP-capable telephonic communications system has been equipped, to execute processing for managing application information of an IP terminal. The program comprises the following steps: causing a dedicated maintenance terminal to execute information extraction processing for extracting application information from a dedicated maintenance terminal database in which application information has been stored, and write-information transmit processing for transmitting application information to a protocol control device via an IP-capable private branch exchange; and causing the protocol control device to execute information write processing for changing application information, which has already been stored in a protocol control device database in which application information of the IP terminal has been stored, to application information that has been transmitted from the IP-capable private branch exchange.

By causing a prescribed apparatus with which an integrated IP-capable telephonic communications system has been equipped to execute the IP terminal information management program created as described above, application information that has been transmitted from the dedicated maintenance terminal can be written to the database of the protocol control device.

Further, according to a tenth aspect of the present invention, there is provided an IP terminal information management program for causing a prescribed apparatus, with which an integrated IP-capable telephonic communications system has been equipped, to execute processing for managing application information of an IP terminal. The program comprises the following steps: causing a dedicated maintenance terminal to execute confirmation request transmit processing for transmitting an IP terminal status confirmation request to an IP-capable private branch exchange; causing the IP-capable private branch exchange to execute status-change confirm processing for checking for a change in status of an IP terminal, and check-result transmit processing for transmitting result of the check of change in status of the IP terminal to the dedicated maintenance terminal; causing the dedicated maintenance terminal to execute information extraction processing for extracting application information from a dedicated maintenance terminal database in which application information has been stored, and write-information transmit processing for transmitting application information to a protocol control device via the IP-capable private branch exchange; and causing the protocol control device to execute information write processing for changing application information, which has already been stored in a protocol control device database in which application information of the IP terminal has been stored, to application information that has been transmitted from the IP-capable private branch exchange.

A prescribed apparatus with which an integrated IP-capable telephonic communications system has been equipped is caused to execute the IP terminal information management program created as described above. As a result, if a user has logged in at an IP terminal, application information concerning this IP terminal can be changed in the protocol control device to application information that has been transmitted from the dedicated maintenance terminal.

Further, according to an eleventh aspect of the present invention, there is provided a protocol control device to which one or more IP terminals are connected and which is connected to an IP-capable private branch exchange, the control device comprising a protocol control device database in which application information of IP terminals has been stored.

If a protocol control device is constructed as set forth above, application information concerning multiple IP terminals can be managed centrally in the protocol control device. This makes it unnecessary to install an external server for storing application information and therefore enables a reduction in equipment cost.

Moreover, it is possible to carry about application information at multiple IP terminals connected to the protocol control device. As a result, the user of an IP terminal can freely select and use any IP terminal.

The meritorious effects of the present invention are summarized as follows.

In accordance with the present invention, application information of a plurality of IP terminals can be managed centrally by a protocol control device, and therefore it is no longer necessary to construct a special-purpose external server for storing application information. As a result, it is possible to reduce the expense of constructing a system for installation of an external server.

Furthermore, the application information of these IP terminals is centrally managed not by each individual IP terminal but by the protocol control device. This means that an IP terminal user can freely select and use the IP terminal (desktop personal computer, notebook personal computer, etc.) desired to be used at the time.

Moreover, operating a dedicated maintenance terminal makes it possible to temporarily save, for back-up, application information in a dedicated maintenance terminal, to change application information in a protocol control device and to change application information in a protocol control device in a case where the user has logged in at the IP terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the configuration of an integrated IP-capable telephonic communications system according to the present invention;

FIG. 2 is a block diagram illustrating the structure of an IP-capable private branch exchange (IP-PBX) in the system according to the present invention;

FIG. 3 is a block diagram illustrating the structure of a dedicated maintenance terminal in the system according to the present invention;

FIG. 4 is a block diagram illustrating the structure of protocol control device in the system according to the present invention;

FIG. 5 is a flowchart illustrating processing for backing up application information of an IP terminal according to the invention;

FIG. 6 is a flowchart illustrating processing for loading application information of an IP terminal according to the invention;

FIG. 7 is a flowchart illustrating processing for log-in at an IP terminal according to the invention; and

FIG. 8 is a flowchart illustrating processing for loading application information when an IP terminal has logged in according to the invention.

### PREFERRED EMBODIMENTS OF THE INVENTION

A preferred embodiment of an integrated IP-capable telephonic communications system, an IP terminal information management, an IP terminal information management program and a protocol control device will now be described in detail with reference to the drawings.

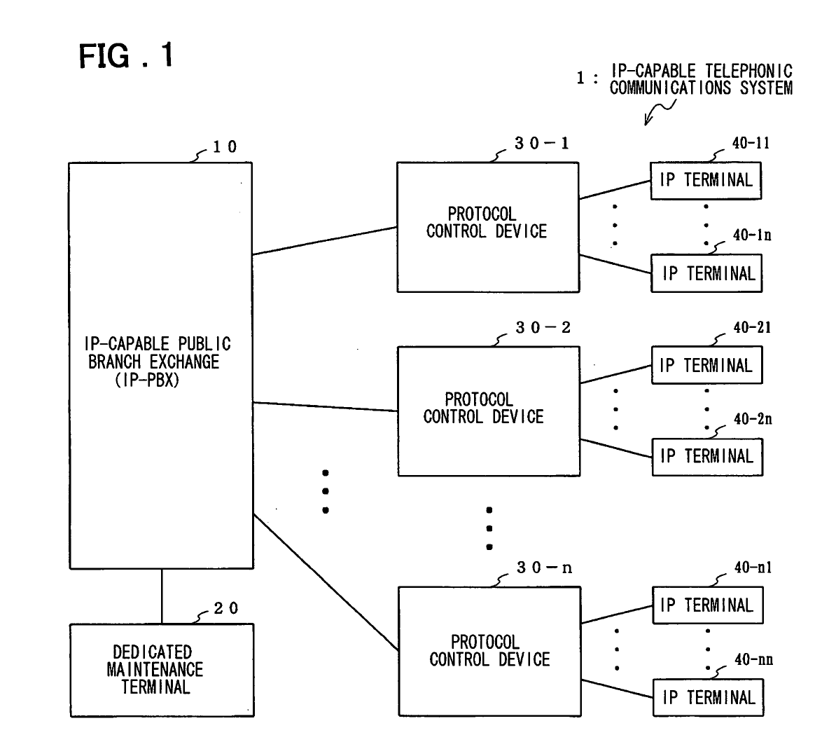

First, the integrated IP-capable telephonic communications system will be described with reference to FIG. 1, which is a block diagram illustrating the configuration of the integrated IP-capable telephonic communications system according to this embodiment.

As illustrated in FIG. 1, an integrated IP-capable telephonic communications system 1 comprises an IP-capable private branch exchange (IP-PBX) 10, a dedicated maintenance terminal 20, protocol control devices 30-1 to 30-n, and IP terminals 40-11 to 40nn.

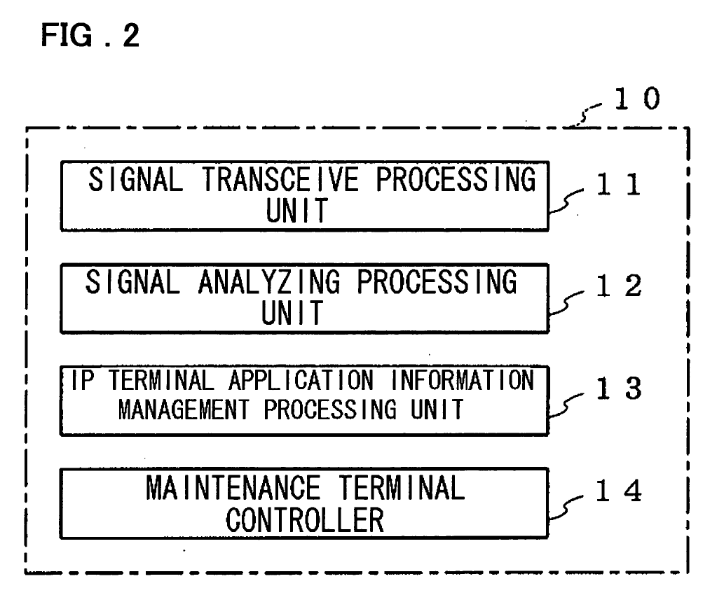

As shown in FIG. 2, the IP-PBX 10 includes a signal transceive processing unit 11, a signal analyzing processing unit 12, an IP terminal application information management processing unit 13 and a maintenance terminal controller 14.

The signal transceive processing unit (a transceive signal processing unit for the IP-capable private branch exchange) 11 implements the sending and receiving of prescribed signals among the protocol control devices 30-1 to 30-n (abbreviated to “protocol control device 30” below).

More specifically, the signal transceive processing unit 11 transmits a command for reading out application information of an IP terminal, a command for loading application information and a signal indicative of log-in enable, and receives the result of read-out of application information, the result of processing for changing the status of an IP terminal, and a log-in request.

The signal analyzing processing unit 12 checks the call status of any of the IP terminals 40-11 to 40-nn (abbreviated to “IP terminal 40” below) that has requested log-in.

Further, the signal analyzing processing unit 12 checks for a change in the status of each IP terminal 40 if an IP terminal status confirmation request is transmitted from the dedicated maintenance terminal 20.

The IP terminal application information management processing unit 13 has a function for managing data representing the extension number of a transfer destination and such information as the states of various keys and buttons and the status of various lamps.

The maintenance terminal controller 14 implements the sending and receiving of prescribed signals to and from the dedicated maintenance terminal 20.

More specifically, the maintenance terminal controller 14 transmits the result of reading out application information and the result of IP-terminal status-change processing, etc., and receives a request to back up application information, application information for writing by the protocol control device 30 and a status confirmation request from each IP terminal.

The dedicated maintenance terminal 20 mainly manages registration/change of the data of each terminal of the IP-PBX 10, manages failure information of the IP-PBX 10 and manages the operating status of the IP-PBX 10 (as by observing traffic).

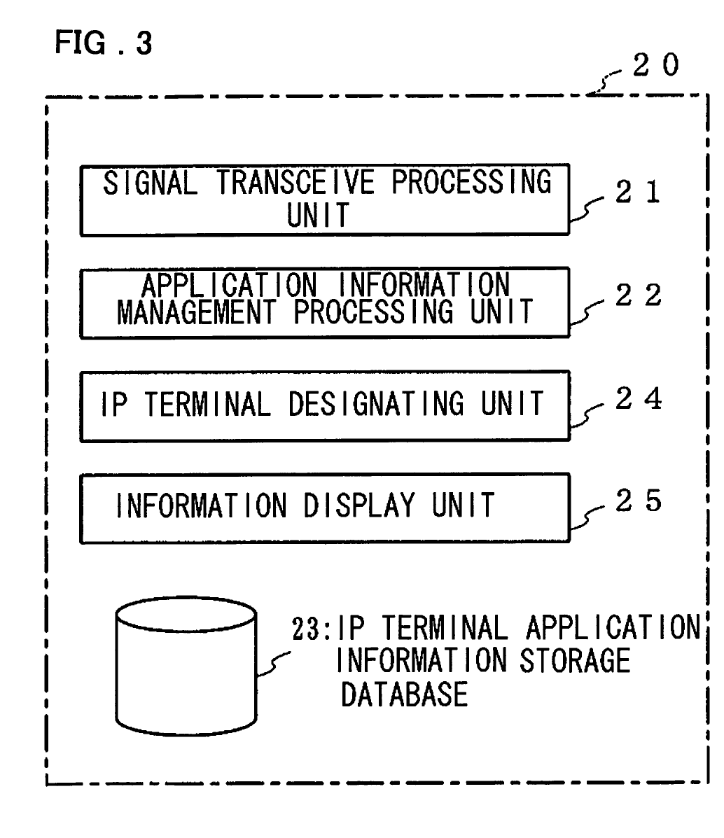

As shown in FIG. 3, the dedicated maintenance terminal 20 includes a signal transceive processing unit 21, an application information management processing unit 22, an IP terminal application information storage database 23, an IP terminal designating unit 24 and an information display unit 25.

The signal transceive processing unit (signal transceive processing unit for the dedicated maintenance terminal) 21 sends and receives prescribed signals (the signals mentioned above in the description of the maintenance terminal controller 14) to and from the IP-PBX 10.

The application information management processing unit 22 manages data that has been stored in the IP terminal application information storage database 23. In particular, the application information management processing unit 22 executes processing for extracting application information of the IP terminal 40, which has been designated by the IP terminal designating unit 24, from the IP terminal application information storage database 23, and processing for writing application information to the IP terminal application information storage database 23.

The IP terminal application information storage database (database for the dedicated maintenance terminal) can be provided on a hard disk, etc., of the dedicated maintenance terminal 20 and saves the application information of the IP terminal 40 as information for back-up purposes. This application information for back-up is transmitted from the protocol control device 30 via the IP-PBX 10.

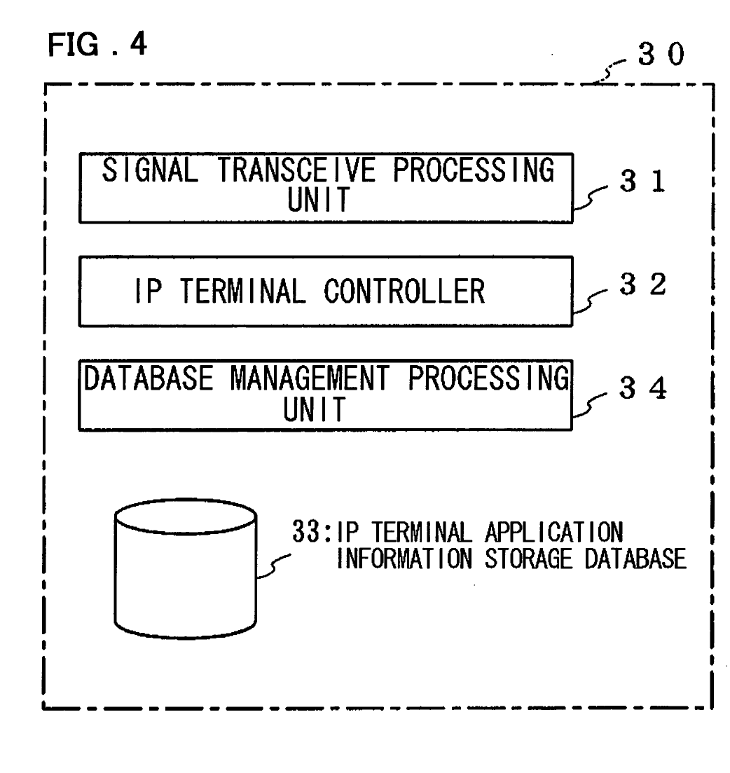

Further, the IP terminal application information storage database 23 stores application information for loading (writing) to a IP terminal application information storage database 33 (see FIG. 4) in the protocol control device 30.

The IP terminal designating unit 24 is an MMI (Man-Machine Interface) used to designate the IP terminal 40 and is operated by a maintenance individual.

The information display unit 25 has a display screen for displaying the result of read-out of application information in the protocol control device 30 (i.e., completion of processing for backing up the application information), the fact that processing for loading (writing) application information has been completed, and the result of processing for status change in the IP terminal 40. This makes it possible for the maintenance individual to acquire knowledge about the nature and content of various results.

The protocol control device 30 is a relay unit for connecting various networks [a LAN (Local Area Network), WAN (Wide Area Network) or the Internet] and various computers (inclusive of the IP terminal 40) together and includes a router, a bridge, a gateway, a repeater or a brouter.

As shown in FIG. 4, the protocol control device 30 includes a signal transceive processing unit 31, an IP terminal controller 32, the IP terminal application information storage database 33 and a database management processing unit 34.

The signal transceive processing unit (signal transceive processing unit for the protocol control device) 31 sends and receives prescribed signals (the signals mentioned above in the description of the signal transceive processing unit 11 of the IP-PBX 10) to and from the IP-PBX 10.

The IP terminal controller 32 sends and receives prescribed signals to and from the IP terminal 40. More specifically, the IP terminal controller 32 transmits a command to change the status of the IP terminal 40 and receives the result of processing to change the status of the IP terminal 40, by way of example.

The IP terminal application information storage database (the database for the protocol control device) 33 stores application information of each IP terminal 40 controlled by the protocol control device 30.

By equipping the protocol control device 30 with a database that stores the application information of each IP terminal 40, equipment cost can be reduced because it is no longer necessary to install an external server for storing application information. Moreover, it becomes possible to carry about application information at the plurality of IP terminals 40 and the user of a IP terminal 40 can freely select the IP terminal 40 to be used.

The database management processing unit 34 manages data that has been stored in the IP terminal application information storage database 33. In particular, the database management processing unit 34 executes processing for extracting application information of an IP terminal 40, which has been designated on the basis of an application-information read-out command from the IP-PBX 10, from the IP terminal application information storage database 33, and processing for writing application information for log-in, which has been transmitted from the IP-PBX 10, to the IP terminal application information storage database 33.

The IP terminal 40, which is a terminal connectable to an IP network, includes an IP telephone, a personal computer (desktop or notebook) equipped with VoIP software, etc.

Upon receiving a status-change command from the protocol control device 30, the IP terminal 40 changes its status and transmits the result of the change to the protocol control device 30. Further, the IP terminal 40 transmits a log-in request to the protocol control device 30 at the time of log-in.

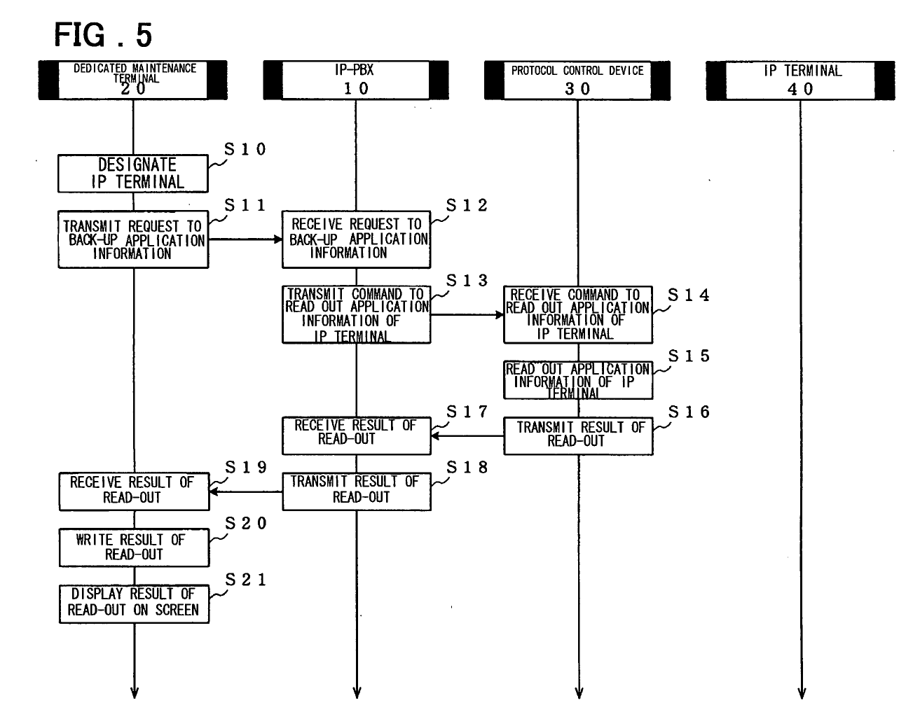

Next, reference will be had to FIG. 5 to describe processing for backing up application information of an IP terminal in this integrated IP-capable telephonic communications system.

The IP terminal 40 of interest is designated by an operation performed by a maintenance individual at the IP terminal designating unit 24 of the dedicated maintenance terminal 20 (step 10). On the basis of the designation made, a request to back up application information (a request to read out application information) is transmitted from the signal transceive processing unit 21 of the dedicated maintenance terminal 20 to the IP-PBX 10 (read-out request transmit processing; step 11).

Upon receiving the application-information back-up request (step 12), the maintenance terminal controller 14 of the IP-PBX 10 transmits a command to read-out the application information that corresponds to the designated IP terminal (IP terminal 40x) to the protocol control device (protocol control device 30x), which is controlling the IP terminal 40x, via the maintenance terminal controller 14, IP terminal application information management processing unit 13 and signal transceive processing unit 11 (read-out command transmit processing; step 13).

Upon receiving the application-information read-out command corresponding to IP terminal 40x (step 14), the signal transceive processing unit 31 of the protocol control device 30x accesses the IP terminal application information storage database 33 and reads out the application information of the IP terminal 40x (information read-out processing; step 15). The result of read-out is transmitted from the signal transceive processing unit 31 to the IP-PBX 10 (step 16).

The reply from the protocol control device 30x (the result of read-out of the application information of IP terminal 40x) is received by the signal transceive processing unit 11 of the IP-PBX 10 (step 17), and the result of read-out is transmitted to the dedicated maintenance terminal 20 via the signal analyzing processing unit 12, IP terminal application information management processing unit 13 and maintenance terminal controller 14 (step 18).

The reply data is received at the dedicated maintenance terminal 20 via the signal transceive processing unit 21 and application information management processing unit 22 (step 19), and the application information of the IP terminal 40x, which information is the result of read-out received, is written to (stored and saved in) the IP terminal application information storage database 23 (read-out result store processing; step 20). As a result, the application information of the designated IP terminal 40, which information is from the application information that has been saved in the protocol control device 30x, is saved in the dedicated maintenance terminal 20 as back-up information.

The result of processing, which includes the result of read-out, is thenceforth displayed on the display screen of the information display unit 25 of dedicated maintenance terminal 20, whereby the maintenance individual is notified of the result (i.e., the fact that processing for backing up the application information has been completed) (step 21).

In this embodiment, the processing whereby the result of read-out of the application information of IP terminal 40 is transmitted from the protocol control device 30 to the dedicated maintenance terminal 20 via the IP-PBX 10 is referred to as “read-out result transmit processing”.

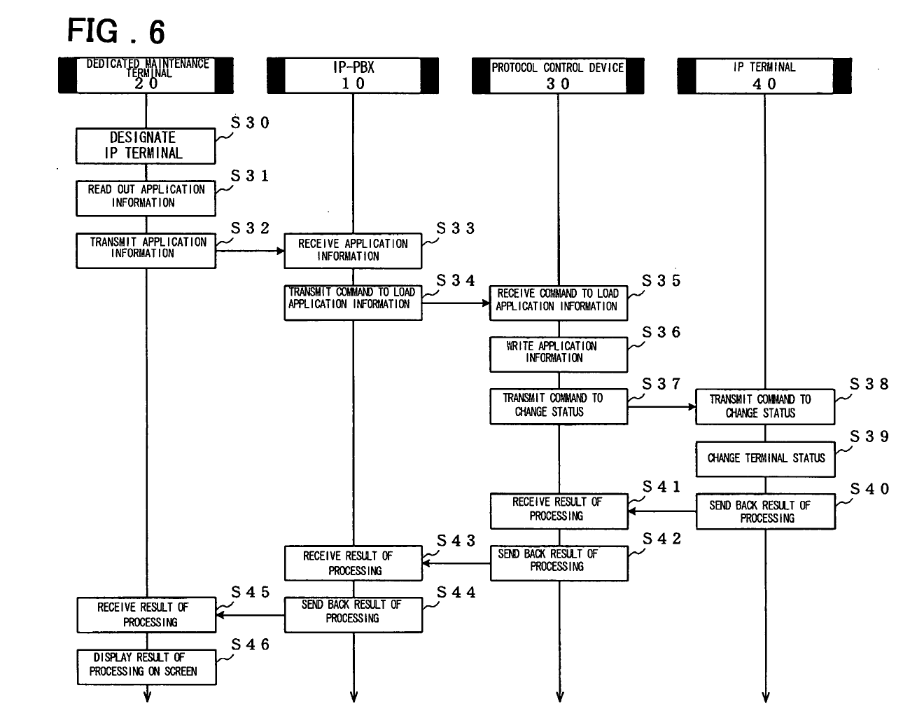

Next, reference will be had to FIG. 6 to describe processing for loading application information of an IP terminal in this integrated IP-capable telephonic communications system.

The IP terminal 40 is designated by the maintenance individual using the IP terminal designating unit 24 of the dedicated maintenance terminal 20 (step 30). As a result, a command to load the application information that has been saved in the application information management processing unit 22 is executed.

If an input command from the maintenance individual is received at the dedicated maintenance terminal 20, the IP terminal application information storage database 23 is accessed and the application information of the designated IP terminal (IP terminal 40x) is read out via the application information management processing unit 22 (information extraction processing; step 31). The read-out application information of the IP terminal 40x is transmitted to the IP-PBX 10 via the signal transceive processing unit 21 (step 32).

The application information of IP terminal 40x is received at the maintenance terminal controller 14 of IP-PBX 10 (step 33) and the application information received is transmitted to the to the protocol control device (protocol control device 30x), which is controlling the IP terminal 40x, via the IP terminal application information management processing unit 13 and signal transceive processing unit 11. In concurrence with the transmission of the application information, the protocol control device 30x is commanded to load (write) the application information for the IP terminal 40x received from the dedicated maintenance terminal 20 (step 34).

In this embodiment, the processing whereby application information is transmitted from the dedicated maintenance terminal 20 to the IP-PBX 10 and the processing whereby the command to load the application information is transmitted from the IP-PBX 10 to the protocol control device 30 shall be referred to collectively as “write-information transmit processing”.

If the command to load the application information for the IP terminal 40x is received at the signal transceive processing unit 31 of the protocol control device 30x (step 35), the IP terminal application information storage database 33 is accessed via the database management processing unit 34 and the application information of IP terminal 40x is written to the database (information write processing; step 36).

Furthermore, on the basis of the application information of IP terminal 40x, a command to change the status of the IP terminal 40x is transmitted to the IP terminal 40x by the IP terminal controller 32 in the protocol control device 30x (step 37).

The status-change command from the protocol control device 30x is received by the IP terminal 40x (step 38), the status of terminal is changed in accordance with this command (step 39), and the result of processing (the result of processing to change the terminal status) is sent back to the protocol control device 30x (step 40).

The IP terminal controller 32 of the protocol control device 30x receives the reply (result of processing) from the IP terminal 40x (step 41) and the result of processing is sent back to the IP-PBX 10 via the signal transceive processing unit 31 (step 42).

The reply (result of processing) from the protocol control device 30x is received at the signal transceive processing unit 11 of the IP-PBX 10 (step 43) and is sent back to the dedicated maintenance terminal 20 by the maintenance terminal controller 14 via the signal analyzing processing unit 12 and IP terminal application information management processing unit 13 (step 44).

The reply from the IP-PBX 10 is received at the signal transceive processing unit 21 of dedicated maintenance terminal 20 (step 45). The result of processing (the result of processing to change terminal status or the result of loading application information of the IP terminal 40x) is thenceforth displayed on the display screen of the information display unit 25 of dedicated maintenance terminal 20 via the application information management processing unit 22, thereby notifying the maintenance individual of the result of processing (step 46).

By virtue of this processing, application information that has been saved in the protocol control device 30 can be loaded (write or update) and attendant processing for changing the status of the IP terminal 40 can be executed.

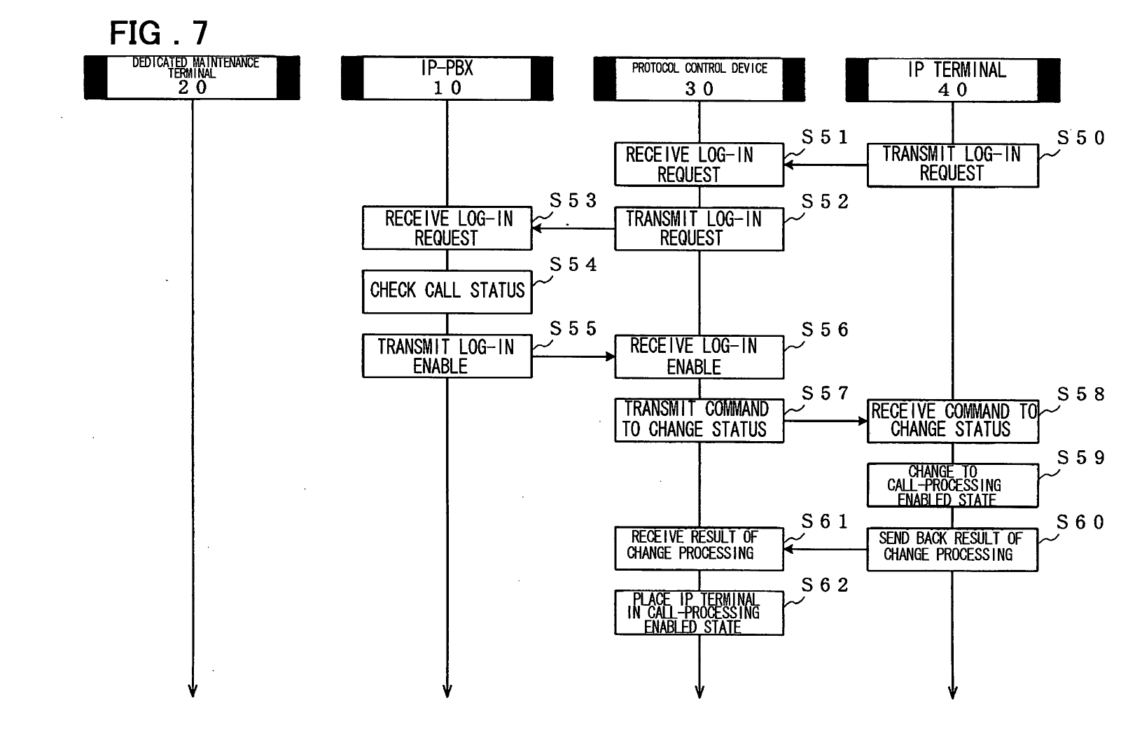

Next, reference will be had to FIG. 7 to describe processing for IP-terminal log-in in this integrated IP-capable telephonic communications system.

Log-in is executed by the user of the IP terminal 40. The IP terminal 40 is commanded by negotiation processing with the IP-PBX so as to be controlled by the protocol control device 30.

A log-in request is transmitted from the IP terminal 40 to the protocol control device 30 (step 50).

If the log-in request is received by the IP terminal controller 32 of the protocol control device 30 (step 51), the request to log in the IP terminal 40 is further transmitted to the IP-PBX 10 via the signal transceive processing unit 31 (step 52).

If the request to log in the IP terminal 40 is received by the signal transceive processing unit 11 of the IP-PBX 10 (step 53), then the call status of the IP terminal 40 is checked by the signal analyzing processing unit 12 (step 54) and log-in is permitted. On the basis of this permission, log-in enable is transmitted from the signal transceive processing unit 11 to the protocol control device 30 (step 55).

If the log-in enable signal from the IP-PBX 10 is received by the signal transceive processing unit 31 of the protocol control device 30 (step 56), then log-in of the IP terminal 40 is allowed by the IP terminal controller 32. In order to change the status of the IP terminal 40 to the logged-in state (the state in which call processing is possible) based upon this log-in enable, a command to change status is transmitted to the IP terminal 40 (step 57).

If the status-change command is received by the IP terminal 40 (step 58), then the status of the terminal is changed on the basis of this status-change command to the state in which call processing is possible (step 59) and the result of this change processing is sent back to the protocol control device 30 (step 60).

If the result of change processing is received by the IP terminal controller 32 of the protocol control device 30 (step 61), then the IP terminal 40 is enabled for call processing (step 62). As a result, processing for logging in the IP terminal 40 ends.

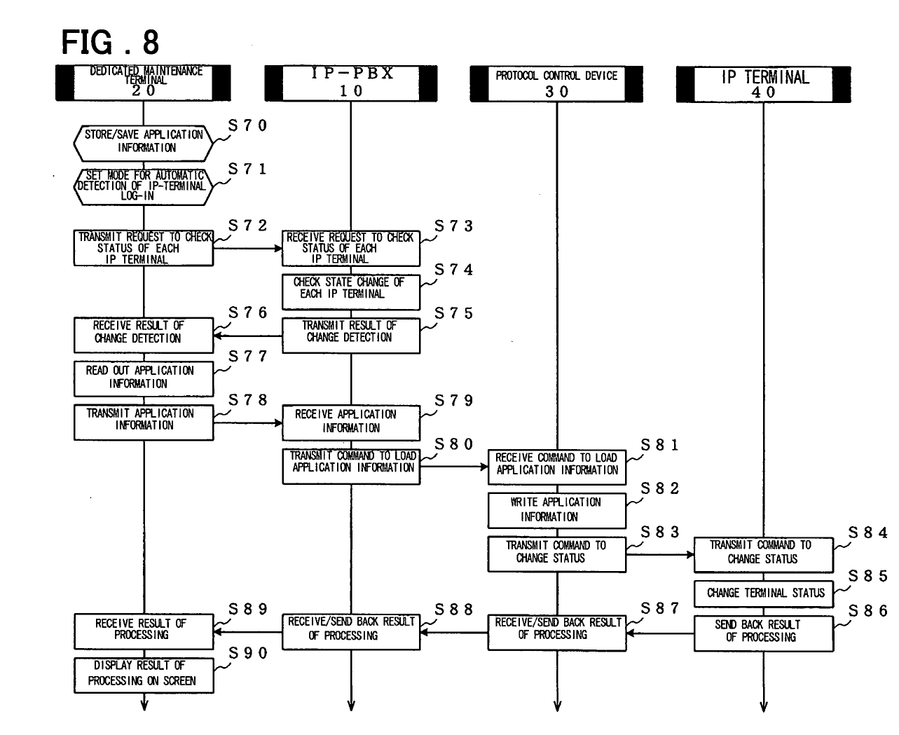

Next, reference will be had to FIG. 8 to describe processing for loading application information at log-in of an IP terminal in this integrated IP-capable telephonic communications system.

Application information of each IP terminal 40 has already been stored and saved in the IP terminal application information storage database 23 of the dedicated maintenance terminal 20 (step 70).

During activation of a command to load IP-terminal application information, the dedicated maintenance terminal 20 is set to a mode for automatically detecting IP-terminal log-in (step 71).

A request to check the status of each IP terminal 40 is transmitted periodically from the signal transceive processing unit 21 of the dedicated maintenance terminal 20 to the IP-PBX 10 (confirmation request transmit processing; step 72).

If the request to check the status of each IP terminal 40 is received by the maintenance terminal controller 14 of the IP-PBX 10 (step 73), a change in the state of each IP terminal 40 is checked at any time by the signal analyzing processing unit 12 in response to the request (status-change confirm processing; step 74). If it is detected in this check of status change that the state of the IP terminal 40x has changed from, e.g., the log-out state to the log-in state (the state in which call processing is possible), then the result of detection of the change is transmitted to the dedicated maintenance terminal 20 via the maintenance terminal controller 14 (check-result transmit processing; step 75).

If the result of the detection of a change is received by the signal transceive processing unit 21 of the dedicated maintenance terminal 20 (step 76), the signal transceive processing unit 21 accesses the IP terminal application information storage database 23 and reads out the application information of the IP terminal 40x via the application information management processing unit 22 (information extraction processing; step 77). The application information is transmitted to the IP-PBX 10 via the signal transceive processing unit 21 (write-information transmit processing; step 78).

If the application information is received by the maintenance terminal controller 14 of the IP-PBX 10 (step 79), then the protocol control device 30 controlling the IP terminal 40x is commanded to load (write) the application information for the IP terminal 40x received from the dedicated maintenance terminal 20, via the maintenance terminal controller 14, IP terminal application information management processing unit 13 and signal transceive processing unit 11 (transmit application-information load command; step 80).

Upon receiving the application-information load command (inclusive of the application information of the IP terminal 40x) (step 81), the signal transceive processing unit 31 of the protocol control device 30 accesses the IP terminal application information storage database 33 via the signal transceive processing unit 31 and writes the application information of the IP terminal 40x (information write processing; step 82).

Furthermore, based upon the application information of the IP terminal 40x, the IP terminal controller 32 of the protocol control device 30 transmits a command to change status to the IP terminal 40x (step 83).

In the IP terminal 40x, the status-change command from the protocol control device 30 is received (step 84), the status of the terminal is changed in accordance with the command (step 85) and the result of processing for changing the status of the terminal (i.e., the result of loading the application information of the IP terminal 40x) is sent back to the protocol control device 30 (step 86).

The sent-back result of processing for changing the status of the terminal is further sent back to the dedicated maintenance terminal 20 via the protocol control device 30 and IP-PBX 10 (signal transceive processing unit 11, signal analyzing processing unit 12, IP terminal application information management processing unit 13 and maintenance terminal controller 14) (receive/send back result of processing; steps 87, 88).

The result of processing for changing the status of the terminal is received by the signal transceive processing unit 21 of the dedicated maintenance terminal 20 (step 89). The result of processing (result of processing for changing the status of the terminal or result of loading the application information of the IP terminal 40x) is displayed on the screen of the information display unit 25 of the dedicated maintenance terminal 20 via the application information management processing unit 22, whereby the maintenance individual is notified (step 90).

A program for managing IP terminal information will be described next.

Various functions (functions for managing IP terminal application information) of computers (IP-PBX, dedicated maintenance terminal, protocol control device and IP terminal) in the above-described embodiment are implemented by an IP terminal information management program that has been stored in storage units of the computers.

By reading the IP terminal information management program into the computer, commands are sent to each of the constituent elements of the computer and the computer is made to execute prescribed processing, e.g., read-out command transmit processing, write-information transmit processing, status-change confirm processing, check-result transmit processing and write-information transmit processing in the IP-PBX; read-out request transmit processing, read-out result store processing, information extraction processing, confirmation request transmit processing and information extraction processing in the dedicated maintenance terminal; information read-out processing, read-out result transmit processing, information write processing and information write processing in the protocol control device, and IP-terminal status-change processing in the IP terminal.

As a result, the functions for managing the application information of IP terminals are implemented by the various items of equipment (IP-PBX, dedicated maintenance terminal, protocol control device and IP terminal) in which there is cooperation between the IP terminal information management program and computer.

It should be noted that the IP terminal information management program for implementing the IP terminal application information management function can be stored on a computer-readable recording medium, e.g., an external storage device and portable recording medium, etc., in addition to the ROM or hard disk, etc., of a computer.

The external storage device is taken to mean additional storage that internally accommodates a storage medium such as a CD-ROM and is externally connected to each item of equipment. The portable recording medium, on the other hand, signifies a recording medium that can be inserted into a recording-medium drive and carried about, e.g., a flexible disk, memory card or magneto-optic disk, etc.

The program that has been recorded on the recording medium is loaded in the computer RAM and executed by the CPU. The functions of each of the items of equipment of the embodiment described above are implemented by such execution.

Furthermore, in a case where the IP terminal information management program is to be loaded by a computer, an IP terminal information management program possessed by another computer can also be downloaded to one's own RAM or external storage device by utilizing a communication line. The IP terminal information management program that has been downloaded also is executed by the CPU so that the IP terminal application information management function of each item of equipment of the embodiment is implemented.

A preferred embodiment of an integrated IP-capable telephonic communications system, IP terminal information management method, IP terminal information management program and protocol control device according to the present invention has been described above. However, it goes without saying that the integrated IP-capable telephonic communications system, IP terminal information management method, IP terminal information management program and protocol control device of the present invention are not limited to the embodiment described above and various modifications can be made within the scope of the invention.

For example, in the embodiment described above, the number of IP terminals designated by the dedicated maintenance terminal is a single terminal. However, the number is not limited to one and a plurality of IP terminals can also be designated.

The present invention relates to management of application information concerning IP terminals and therefore can be utilized in networks and systems that manage such application information.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. An integrated IP-capable telephonic communications system having a protocol control device to which one or more IP terminals have been connected, an IP-capable private branch exchange to which one or more protocol control devices have been connected, and a dedicated maintenance terminal connected to the IP-capable private branch exchange, wherein:
said protocol control device has a protocol control device database in which application information of each IP terminal has been stored;
said IP-capable private branch exchange, based upon an application information read-out request from said dedicated maintenance terminal, transmits an application information read-out command to said protocol control device and transmits application information from said protocol control device to said dedicated maintenance terminal; and
said dedicated maintenance terminal has a dedicated maintenance terminal database in which application information is stored and is adapted to store the application information from said IP-capable private branch exchange in said dedicated maintenance terminal database.

2. The system according to claim 1, wherein said protocol control device includes:
said protocol control device database;
a database management processing unit for extracting the application information from said protocol control device database based upon the application information read-out command from said IP-capable private branch exchange; and
a protocol control device signal transceive processing unit for transmitting the extracted application information to said IP-capable private branch exchange;
said IP-capable private branch exchange includes:
a maintenance terminal controller for receiving the application information read-out request from said dedicated maintenance terminal and transmitting the application information to said dedicated maintenance terminal; and
a transceive signal processing unit for said IP-capable private branch exchange for transmitting the application information read-out command to said protocol control device and receiving the application information from said protocol control device; and
said dedicated maintenance terminal includes:
said dedicated maintenance terminal database;
a dedicated maintenance terminal signal transceive processing unit for transmitting the application information read-out request to said IP-capable private branch exchange and receiving the application information from said IP-capable private branch exchange; and
an application information management processing unit for storing application information, which has been received by this dedicated maintenance terminal signal transceive processing unit, in said dedicated maintenance terminal database.

3. An integrated IP-capable telephonic communications system having a protocol control device to which one or more IP terminals have been connected, an IP-capable private branch exchange to which one or more protocol control devices have been connected, and a dedicated maintenance terminal connected to the IP-capable private branch exchange, wherein:
said dedicated maintenance terminal has a dedicated maintenance terminal database in which application information has been stored and extracts the application information from the dedicated maintenance terminal database and transmits it to said IP-capable private branch exchange;
said IP-capable private branch exchange transmits the application information from said dedicated maintenance terminal to said protocol control device; and
said protocol control device has a protocol control device database in which application information of said IP terminal has been stored and changes application information, which has been stored in this protocol control device database, to application information that has been transmitted from said IP-capable private branch exchange.

4. An integrated IP-capable telephonic communications system having a protocol control device to which one or more IP terminals have been connected, an IP-capable private branch exchange to which one or more protocol control devices have been connected, and a dedicated maintenance terminal connected to the IP-capable private branch exchange, wherein:
said IP-capable private branch exchange, based upon an IP terminal status confirmation request from said dedicated maintenance terminal, checks a change in status of an IP terminal and transmits result of the check to said dedicated maintenance terminal;
said dedicated maintenance terminal has a dedicated maintenance terminal database in which application information has been stored and extracts the application information from said dedicated maintenance terminal database and transmits it to said IP-capable private branch exchange;
said IP-capable private branch exchange transmits the application information from said dedicated maintenance terminal to said protocol control device; and
said protocol control device has a protocol control device database in which application information of said IP terminal has been stored and changes application information, which has been stored in this protocol control device database, to application information that has been transmitted from said IP-capable private branch exchange.

5. An IP terminal information management method for managing application information of an IP terminal in an integrated IP-capable telephonic communications system, said method comprising:
read-out request transmit processing for transmitting an application information read-out request from a dedicated maintenance terminal to an IP-capable private branch exchange;
read-out command transmit processing for transmitting an application information read-out command from said IP-capable private branch exchange to a protocol control device;
information read-out processing executed by said protocol control device for extracting application information from a protocol control device database in which application information of IP terminals has been stored;
read-out result transmit processing for transmitting the extracted application information from said protocol control device to said dedicated maintenance terminal via said IP-capable private branch exchange; and
read-out result store processing executed by said dedicated maintenance terminal for storing application information from said IP-capable private branch exchange to a dedicated maintenance terminal database in which the application information is stored.

6. An IP terminal information management method for managing application information of an IP terminal in an integrated IP-capable telephonic communications system, said method comprising:
information extraction processing executed by a dedicated maintenance terminal for extracting application information from a dedicated maintenance terminal database in which the application information has been stored;
write-information transmit processing for transmitting the application information from said dedicated maintenance terminal to a protocol control device via an IP-capable private branch exchange; and
information write processing executed by said protocol control device for changing application information, which has already been stored in a protocol control device database in which application information of IP terminals has been stored, to application information that has been transmitted from said IP-capable private branch exchange.

7. An IP terminal information management method for managing application information of an IP terminal in an integrated IP-capable telephonic communications system, said method comprising:
confirmation request transmit processing for transmitting an IP terminal status confirmation request from a dedicated maintenance terminal to an IP-capable private branch exchange;
status-change confirm processing executed by said IP-capable private branch exchange for checking for a change in status of said IP terminal;
check-result transmit processing for transmitting result of the check of change in status of said IP terminal from said IP-capable private branch exchange to said dedicated maintenance terminal;
information extraction processing executed by said dedicated maintenance terminal for extracting application information from a dedicated maintenance terminal database in which application information has been stored;
write-information transmit processing for transmitting the application information from said dedicated maintenance terminal to a protocol control device via said IP-capable private branch exchange; and
information write processing executed by said protocol control device for changing application information, which has already been stored in a protocol control device database in which application information of said IP terminal has been stored, to application information that has been transmitted from said IP-capable private branch exchange.

8. An IP terminal information management program for causing a prescribed apparatus, with which an integrated IP-capable telephonic communications system has been equipped, to execute processing for managing application information of an IP terminal, said program comprising:
causing a dedicated maintenance terminal to execute read-out request transmit processing for transmitting an application information read-out request to an IP-capable private branch exchange;
causing said IP-capable private branch exchange to execute read-out command transmit processing for transmitting an application information read-out command to a protocol control device based upon receipt of the application information read-out request;
causing said protocol control device to execute information read-out processing for extracting the application information from a protocol control device database in which application information of each IP terminals has been stored, and read-out result transmit processing for transmitting the extracted application information to said dedicated maintenance terminal via said IP-capable private branch exchange; and
causing said dedicated maintenance terminal to execute read-out result store processing for storing the application information from said IP-capable private branch exchange to a dedicated maintenance terminal database in which application information is stored.

9. An IP terminal information management program for causing a prescribed apparatus, with which an integrated IP-capable telephonic communications system has been equipped, to execute processing for managing application information of an IP terminal, said program comprising:
causing a dedicated maintenance terminal to execute information extraction processing for extracting the application information from a dedicated maintenance terminal database in which application information has been stored, and write-information transmit processing for transmitting the application information to a protocol control device via an IP-capable private branch exchange; and
causing said protocol control device to execute information write processing for changing application information, which has already been stored in a protocol control device database in which application information of said IP terminal has been stored, to application information that has been transmitted from said IP-capable private branch exchange.

10. An IP terminal information management program for causing a prescribed apparatus, with which an integrated IP-capable telephonic communications system has been equipped, to execute processing for managing application information of an IP terminal, said program comprising:
causing a dedicated maintenance terminal to execute confirmation request transmit processing for transmitting an IP terminal status confirmation request to an IP-capable private branch exchange;
causing the IP-capable private branch exchange to execute status-change confirm processing for checking for a change in status of said IP terminal, and check-result transmit processing for transmitting result of the check of change in status of the IP terminal to said dedicated maintenance terminal;
causing said dedicated maintenance terminal to execute information extraction processing for extracting application information from a dedicated maintenance terminal database in which application information has been stored, and write-information transmit processing for transmitting the application information to a protocol control device via said IP-capable private branch exchange; and
causing said protocol control device to execute information write processing for changing application information, which has already been stored in a protocol control device database in which application information of said IP terminal has been stored, to application information that has been transmitted from said IP-capable private branch exchange.

11. A protocol control device to which one or more IP terminals are connected and which is connected to an IP-capable private branch exchange, said protocol control device comprising a protocol control device database in which application information of said IP terminals has been stored.
